(19) United States
(12) Patent Application Publication
(10) Pub. No.: US 2026/0216685 A1
(43) Pub. Date: Jul. 30, 2026

(54) THREE-LAYER NESTED TUBE MICROCHANNEL JET REACTOR

(71) Applicant: Shihezi University, Shihezi (CN)

(72) Inventors: Haojie LI, Shihezi (CN); Xingbo SHAO, Shihezi (CN); Junheng GUO, Shihezi (CN); Jinli ZHANG, Shihezi (CN); Bingliang ZHANG, Shihezi (CN)

(73) Assignee: Shihezi University, Shihezi (CN)

(21) Appl. No.: 19/578,537

(22) Filed: Mar. 25, 2026

Related U.S. Application Data
(63) Continuation of application No. PCT/CN2026/071235, filed on Jan. 8, 2026.

(30) Foreign Application Priority Data
Sep. 19, 2025 (CN) 202511347659.9

(51) Int. Cl. B01J 19/18; B01J 19/00

(52) U.S. Cl. CPC B01J 19/1843; B01J 19/0093; B01J 19/1806; B01J 2219/00777; B01J 2219/00797; B01J 2219/185; B01J 2219/1926

(57) ABSTRACT

The present disclosure provides a three-layer nested tube microchannel jet reactor, which effectively solves problems of difficulty in dispersing high-viscosity mixed system and poor mixing and heat exchange efficiency. To promote dispersed mixing, a generating jet effects through fluid flow, enhancing turbulence, breaking the laminar flow of high-viscosity systems, and promoting mixing; first arc-shaped deflectors on the outer wall of the first inner tube guide a fluid in the first inner annular gap, changing flow field, increasing turbulence and shear, and enhancing mixing. In terms of heat exchange, a three-layer nested tube structure is adopted, with the first and second tube sections having inner, middle, and outer tubes and corresponding annular gaps respectively. The multi-annular-gap structure increases a heat exchange area, allowing sufficient heat exchange between fluids flowing in different annular gaps, wherein flow of multiple fluids enhances convective heat transfer, improving overall heat exchange efficiency.

### TECHNICAL FIELD

The present disclosure relates to the field of microreactor technology, and specifically relates to a three-layer nested tube microchannel jet reactor.

### BACKGROUND ART

Against a backdrop of strengthened chemical processes, technological innovation continues to drive an improvement of industry efficiency and production capacity. Where, microchannel reactor technology is gradually replacing traditional kettle reaction equipment with an excellent mass and heat transfer performance, becoming a new favorite in the fields of fine chemicals, pharmaceuticals, and new material synthesis. A transformation of this background not only stems from a pursuit of more efficient and compact production processes, but also reflects demanding requirements of modern chemical production for precise control of reaction conditions. With an advancement of science and technology and a diversification of market demand, a demand for multi-level, multiphase, and highly selective reactions has sharply increased. These complex reactions often require reactors to have higher mixing efficiency, better mass and heat transfer performance, and more flexible operational flexibility. As a type of microchannel reactor, a microjet reactor achieves micro dispersion of fluids through strong shear force generated by a high-speed jet, thereby demonstrating significant advantages in improving mixing efficiency.

However, despite an excellent performance of microjet reactors and existing single-pole and double-layer nested tube jet reactors in specific scenarios, they still expose many shortcomings when facing increasingly complex reaction demands. For high viscosity or easily agglomerated materials, a single dispersed layer jet method often leads to uneven distribution of droplet or bubble size, where forming local mixing dead zones, which seriously affects an uniformity of a product. In multiphase reactions, traditional jet technology is difficult to simultaneously optimize gas-phase dissolution, liquid-phase mass transfer, and solid-phase contact efficiency, thereby limiting the selectivity and rate of the reaction.

In addition, although existing casing jet reactors have been optimized in terms of geometric structure, such as shortening diffusion distance, increasing interface area, or using vortices and jet oscillations to disrupt a laminar boundary layer, these improvements have not completely solved all problems. A single jet mixing method cannot meet complex reaction requirements that require time and space for stepwise feeding; an introduction of a third phase substance is difficult and can easily lead to flow field disturbances and uneven mixing; for reactions sensitive to a concentration of key components, a double-layer nested tube structure is difficult to maintain a smooth concentration distribution, which can easily lead to local overheating or selective decrease; and in high viscosity systems, dispersion and mixing of materials face significant challenges.

In summary, although microchannel reactor technology has brought new possibilities for enhancing chemical processes, existing technologies still have many limitations in addressing complex reaction requirements. In the future, further technological innovation and optimization are needed to meet an urgent demand for efficient, flexible, and controllable reactors in modern chemical production.

### SUMMARY

In response to problems existing in prior art, the present disclosure provides a three-layer nested tube microchannel jet reaction system, thereby solving technical problems of difficulty in dispersing high viscosity mixed systems, poor mixing efficiency and heat exchange efficiency in a dual-layer nested tube microjet reactor in the prior art. At the same time, the present disclosure also solves technical problem of difficulty in introducing a third phase.

The present disclosure is implemented through following technical solutions:
A three-layer nested tube microchannel jet reactor, including: a first tube section and a second tube section;
where the first tube section includes: a first inner tube, a first middle tube, and a first outer tube coaxially sleeved from inside out; where a first inner annular gap is formed between the first inner tube and the first middle tube; and a first outer annular gap is formed between the first middle tube and the first outer tube;
where the first middle tube is set with several first conical holes; and where an outer wall of the first inner tube is set with several first arc-shaped deflectors;
the second tube section includes: a second inner tube, a second middle tube, and a second outer tube; where a second inner annular gap is formed between the second inner tube and the second middle tube; and a second outer annular gap is formed between the second middle tube and the second outer tube;
the second inner tube is connected to the first inner tube, and the second middle tube is connected to the first middle tube, where the first inner annular gap is connected to the second inner annular gap.

In some embodiments, the first middle tube includes: a first tube body, a second tube body, a third tube body, a fourth tube body, a fifth tube body, and a sixth tube body, where the first tube body, the second tube body, the third tube body, the fourth tube body, the fifth tube body, and the sixth tube body are sequentially connected and arranged, where the first tube body, second tube body, third tube body, fourth tube body, fifth tube body, and sixth tube body can be integrated; a cross-section of the second tube body along an axial direction of the second tube body is trapezoidal, and an inner diameter of the second tube body gradually decreases from an end of the second tube body connected to the first tube body to an other end of the second tube body connected to the third tube body; a cross-section of the fourth tube body along an axial direction of the fourth tube body is trapezoidal, and an inner diameter of the fourth tube body gradually increases from an end of the fourth tube body connected to the third tube body to an other end of the fourth tube body connected to the fifth tube body.

In some embodiments, the sixth tube body is trumpet shaped; where an end of the first inner tube connected to the second inner tube is trumpet shaped.

In some embodiments, first arc-shaped deflectors are set in an area where the fourth tube body and the fifth tube body coincide along an axial direction.

In some embodiments, the first conical holes are set on an outer wall of the third tube body.

In some embodiments, several second arc-shaped deflectors are set on an outer wall of the fourth tube body and an outer wall of the fifth tube body.

In some embodiments, spiral deflectors are arranged on an inner wall and an outer wall of the second inner tube and an inner wall and an outer wall of the second middle tube.

In some embodiments, an outer wall of the second inner tube is corrugated.

In some embodiments, several second conical holes are set on the first inner tube, where each of the second conical holes along an axial direction of the first inner tube coincides with each of the first conical holes along the axial direction of the first inner tube one by one.

In some embodiments, several third conical holes are set on the second middle tube.

Compared with existing technology, the present disclosure has following beneficial technical effects:

The three-layer nested tube microchannel jet reactor of the present disclosure effectively improves the problems of difficulty in dispersing high-viscosity mixed systems, poor mixing efficiency and heat exchange efficiency in the prior art. In terms of dispersing and mixing, several first conical holes are set on the first middle tube. When fluid flows through, special shape of the conical holes can generate a jet effect, causing the fluid to be ejected at high speed, enhancing a turbulence level of the fluid, helping to break a laminar state of high-viscosity systems, promoting dispersion and mixing of different components, and improving the mixing efficiency. At the same time, several first arc-shaped deflectors set on the outer wall of the first inner tube can guide a fluid flow direction in the first inner annular gap, change a flow field distribution of the fluid, further increase a turbulence and shear effects of the fluid, and continuously divide and recombine high-viscosity fluid during a flow process, where enhancing a mixing effect. In terms of heat exchange efficiency, the reactor adopts a three-layer nested tube structure. The first tube section is coaxially fitted with a first inner tube, a first middle tube, and a first outer tube from inside out, forming a first inner annular gap and a first outer annular gap; the second tube section also has a second inner tube, a second middle tube, and a second outer tube, as well as corresponding second inner and second outer annular gaps. The second inner tube is connected to the first inner tube, and the second middle tube is connected to the first middle tube, so that the first inner annular gap is connected to the second inner annular gap. The multi-annular-gap structure increases heat exchange area, and when the fluid flows in different gaps, it can fully exchange heat with the tube wall. At the same time, a flow of multiple fluids can enhance convective heat transfer, thereby improving an overall heat exchange efficiency, effectively solving the problems of dispersing high-viscosity mixed systems, poor mixing efficiency and heat exchange efficiency in existing technology.

Furthermore, the first middle tube includes a first tube body, a second tube body, a third tube body, a fourth tube body, a fifth tube body, and a sixth tube body, where the first tube body, second tube body, third tube body, fourth tube body, fifth tube body, and sixth tube body are sequentially connected and arranged, where the first tube body, second tube body, third tube body, fourth tube body, fifth tube body, and sixth tube body can be integrated. A cross-section of the second tube body along an axial direction of the second tube body is trapezoidal, and an inner diameter of the second tube body gradually decreases from an end of the second tube body connected to the first tube body to an other end of the second tube body connected to the third tube body; a cross-section of the fourth tube body along an axial direction of the fourth tube body is trapezoidal, and an inner diameter of the fourth tube body gradually increases from an end of the fourth tube body connected to the third tube body to an other end of the fourth tube body connected to the fifth tube body. The first middle tube is divided into multiple tube bodies and can be integrated, making it more flexible and easy to be manufactured structurally. The inner diameter of the second tube body gradually decreases, which can increase a flow velocity of the fluid as it flows through, enhancing a kinetic energy and turbulence level of the fluid. The inner diameter of the fourth tube body gradually increases, which can reduce a fluid flow velocity, generate pressure changes, and cooperate with the second tube body to form a pressure gradient, where further enhancing the turbulence and mixing effect of the fluid, and helping to disperse and mix high-viscosity systems.

Furthermore, the sixth tube body is trumpet shaped, which can guide a diffusion of fluid, allowing the fluid to enter a subsequent channel more evenly and expanding a range of fluid action. One end of the first inner tube connected to the second inner tube is also trumpet shaped, which facilitates a smooth transition of fluid when the two tubes are connected, where reducing fluid flow resistance, ensuring stable fluid flow, and improving an overall performance of the reactor.

Furthermore, the first arc-shaped deflectors are set in an area where the fourth and fifth tube bodies coincide along an axial direction, and can guide and adjust a special flow field generated by change in the diameter of the fourth tube body in this area, enhance turbulence and shear effects of the fluid in specific areas, and further optimize a mixing effect of high-viscosity fluids.

Furthermore, the first conical holes are set on the outer wall of the third tube body, which is located in the middle of the first middle tube. By setting conical holes here, the fluid can generate a jet effect at an appropriate flow stage, effectively breaking a laminar flow state of the fluid, enhancing a turbulence level of the fluid, promoting mixing of different components, and improving mixing efficiency.

Furthermore, several second arc-shaped deflectors are set on the outer wall of the fourth and fifth tube bodies, which can guide a flow direction of the fluid near the outer wall, increasing relative motion between the fluid and the tube wall, enhancing a convective heat transfer effect, and further enhance a turbulence of the fluid, which is conducive to a mixing and heat exchange of high-viscosity fluids.

Furthermore, spiral deflectors are set in areas near the inner and outer walls of the second inner tube, as well as in the areas near the inner and outer walls of the second middle tube, which can generate spiral motion of the fluid during a flow process, increase flow paths and turbulence degree of the fluid, enhance a mixing effect of the fluid, and at the same time, spiral flow can enhance convective heat transfer, improve heat exchange efficiency, and enhance a mixing and heat exchange performance of high-viscosity systems.

Furthermore, the outer wall of the second inner tube is corrugated, which increases a surface area of the outer wall. When the fluid flows through, a contact area with the tube wall increases, which is conducive to heat transfer and improves heat exchange efficiency. At the same time, corrugated structure can generate local turbulence, enhance relative motion between the fluid and the tube wall, and further strengthen heat exchange and mixing effect.

Furthermore, the first inner tube is equipped with several second conical holes, axial position of which coincides with the axial position of the first conical hole, effectively achieving an introduction of a third phase reaction solution.

Furthermore, several third conical holes are set on the second middle tube to effectively introduce the third phase reaction solution.

### BRIEF DESCRIPTION OF THE DRAWINGS

In order to provide a clearer explanation of technical solution of the embodiments of the present disclosure, a brief introduction will be given below to accompanying drawings required for use in the embodiments. It should be understood that following drawings only illustrate certain embodiments of the present disclosure and should not be considered as limiting a scope. For those skilled in the art, other relevant drawings can be obtained based on these drawings without creative labor.

FIG. 1 shows a front view of the three-layer nested tube microchannel jet reactor in the present disclosure;

FIG. 2 shows a left view of the three-layer nested tube microchannel jet reactor in the present disclosure;

FIG. 3 shows a schematic diagram of a local structure of the first tube section;

FIG. 4 shows a schematic diagram of settings of the spiral deflectors in the present disclosure;

FIG. 5 shows a schematic diagram of settings of the second arc-shaped deflectors in the present disclosure;

FIG. 6 shows an enlarged schematic diagram of the second arc-shaped deflectors in the present disclosure; and

FIG. 7 shows a schematic diagram of a multi-tube opening structure for introducing a third phase into the three-layer nested tube microchannel jet reactor in the present disclosure.

Reference Numerals: 1: first tube section; 11: first inner tube; 12: first middle tube; 13: first outer tube; 111: first arc-shaped deflector; 112: first working fluid flow port; 121: first conical hole; 122: second arc-shaped deflector; 123: second working fluid flow port; 131: third working fluid flow port; 132: fourth working fluid flow port; 14: first inner annular gap; 15: first outer annular gap; 2: second tube section; 21: second inner tube; 22: second middle tube; 23: second outer tube; 211: fifth working fluid flow port; 221: sixth working fluid flow port; 231: seventh working fluid flow port; 232: eighth working fluid flow port; 24: second inner annular gap; 25: second outer annular gap; 3: spiral deflector; 41: first tube body; 42: second tube body;
43: third tube body; 44: fourth tube body; 45: fifth tube body; 46: sixth tube body; 113: second conical hole; 222: third conical hole.

### DETAILED DESCRIPTION OF THE EMBODIMENTS

In order to clarify purpose, technical solution, and advantages of the embodiments of the present disclosure, the following will provide a clear and complete description of technical solution in the embodiments of the present disclosure in conjunction with accompanying drawings. Obviously, the described embodiments are a part of the embodiments of the present disclosure, not all of them. Components of the embodiments of the present disclosure described and illustrated in the accompanying drawings can be arranged and designed in various different configurations.

Therefore, detailed description of the embodiments of the present disclosure provided in the accompanying drawings is not intended to limit a scope of claimed disclosures, but only to represent selected embodiments of the present disclosure. Based on the embodiments of the present disclosure, all other embodiments obtained by ordinary skilled persons in the art without creative labor are within the scope of protection of the present disclosure.

It should be noted that similar labels and letters represent similar items in following figures. Therefore, once an item is defined in one figure, it does not need to be further defined and explained in subsequent figures.

In description of the embodiments of the present disclosure, it should be noted that a use of terms such as “up”, “down”, “horizontal”, “inside” to indicate orientation or position relationships. which are orientation or position relationships shown in the accompanying drawings, or orientation or position relationships commonly used when using a product of the present disclosure, is only for a convenience of describing the present disclosure and simplifying a description, and does not indicate or imply that a device or component referred to must have a specific orientation, be constructed and operated in a specific orientation, and therefore cannot be understood as a limitation of the present disclosure. In addition, terms “first”, “second”, etc. are only used to distinguish descriptions and cannot be understood as indicating or implying relative importance.

In addition, if a term “horizontal” appears, it does not mean that the component is required to be absolutely horizontal, but can be slightly tilted. For example, “horizontal” only refers to a direction being more horizontal relative to “vertical”, and does not necessarily mean that a structure must be completely horizontal, but can be slightly tilted.

In a description of the embodiments of the present disclosure, it should be noted that unless otherwise specified and limited, the terms “setting”, “installation”, “link”, and “connection” should be broadly understood, for example, they can be fixed connections, detachable connections, or integrated connections; they can be mechanical connections or electrical connections; they can be directly connected, indirectly connected through an intermediate medium, or connected internally between two components. For ordinary technical personnel in this field, specific meanings of above terms in the present disclosure can be understood according to a specific situation.

The present disclosure will be further described in detail with reference to the accompanying drawings.

### Embodiment 1

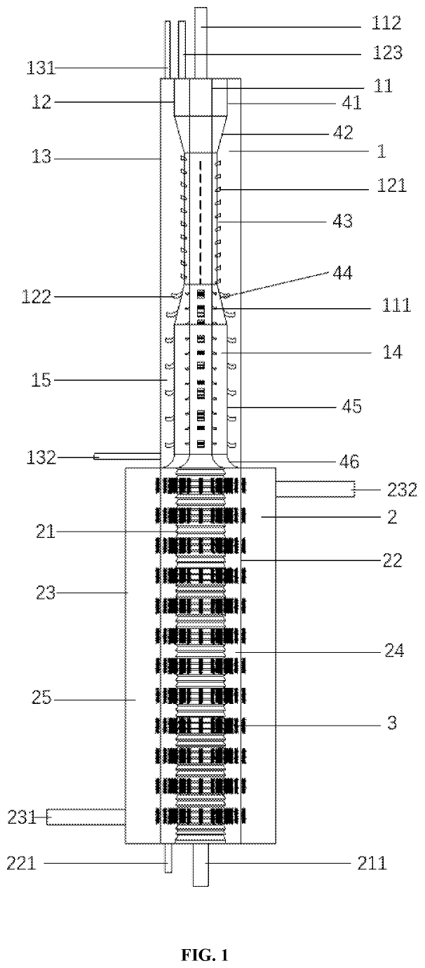

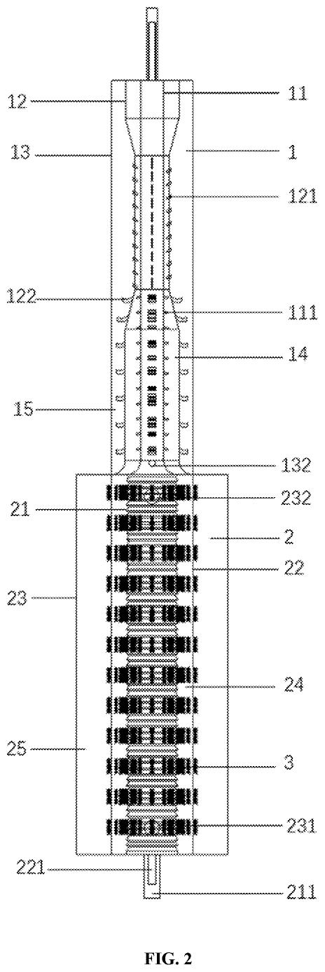

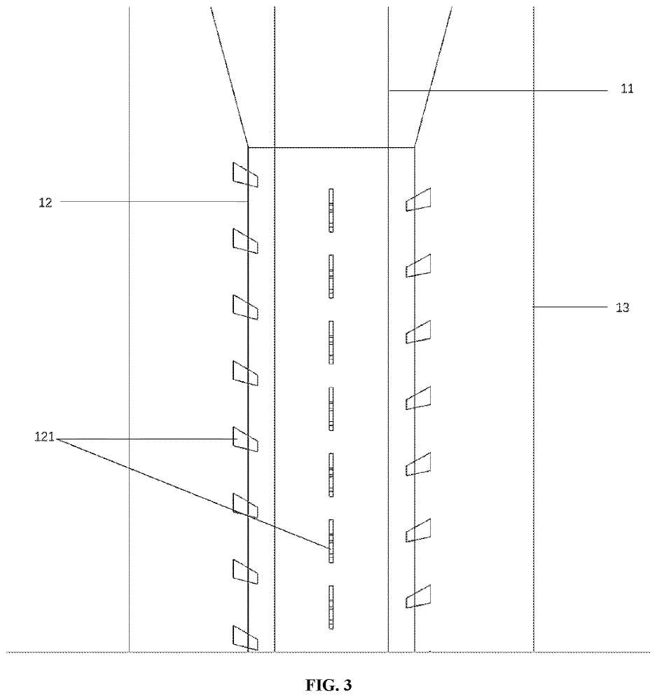

As shown in FIGS. 1-3, the present disclosure discloses a three-layer nested tube microchannel jet reactor, including a first tube section 1 and a second tube section 2.

The first tube section 1 includes: a first inner tube 11, a first middle tube 12, and a first outer tube 13 coaxially sleeved from inside out. A first inner annular gap 14 is formed between the first inner tube 11 and the first middle tube 12; and a first outer annular gap 15 is formed between the first middle tube 12 and the first outer tube 13.

The first middle tube 12 is set with several first conical holes 121; where an outer wall of the first inner tube 11 is set with several first arc-shaped deflectors 111; where setting the first arc-shaped deflectors 111 here will cause a secondary reflux of a working fluid for further mixing. Further in some embodiments, an arrangement of the first arc-shaped deflectors 111 on the outer wall of the first inner tube 11 is uneven, so that liquid generates a low-pressure vortex at this moment, fully mixing the materials.

The second tube section 2 includes: a second inner tube 21, a second middle tube 22, and a second outer tube 23. A second inner annular gap 24 is formed between the second inner tube 21 and the second middle tube 22; and a second outer annular gap 25 is formed between the second middle tube 22 and the second outer tube 23.

The second inner tube 21 is connected to the first inner tube 11, and the second middle tube 22 is connected to the first middle tube 12, where the first inner annular gap 14 is connected to the second inner annular gap 24.

For setting of working fluid flow port, specifically: one side of the first inner tube 11 is set with a first working fluid flow port 112; one side of the first inner annular gap 14 is set with a second working fluid flow port 123; one side of the first outer annular gap 15 is set with a third working fluid flow port 131; the other side of the first outer tube 13 is set with a fourth working fluid flow port 132; the other side of the second inner tube 21 is connected to a fifth working fluid flow port 211; and the other side of the second inner annular gap 24, that is a free end of the second inner annular gap 24, is set with a sixth working fluid flow port 221. The other side of the second outer tube 23 is set with a seventh working fluid flow port 231; one side of the second outer tube 23 is set with an eighth working fluid flow port 232. These working fluid flow ports can be flexibly and cooperatively used to achieve a mixing of reactants and temperature control.

In the embodiment, through a combination of two triple tubes, when conducting a mixed reaction of two-phase reactants, the second working fluid flow port 123 is used as an inlet of reactant one, the third working fluid flow port 131 is used as an inlet of reactant two, the fifth working fluid flow port 211 and the seventh working fluid flow port 231 are used as inlet of condensing medium, and the first working fluid flow port 112 and the eighth working fluid flow port 232 are used as an outlet of condensing medium. During use, reactant one is introduced through the second working fluid flow port 123, reactant two is introduced through the third working fluid flow port 131, and reactant two is further sprayed into the first inner annular gap 14 through the first conical holes 121 set on the first middle tube 12, and mixed with reactant one in the first inner annular gap 14. After mixing, the mixture is subjected to turbulence generated by the first arc-shaped deflectors 111 set on the first inner tube 11 for mixing evenly, and then enters the second inner annular gap 24. After a reaction, reaction product flows out from the sixth working fluid flow port 221.

Further in some embodiments, the outer wall of the second inner tube 21 is designed in a corrugated shape, which can form a turbulent effect, enhance mixing, and effectively improve a mixing effect between reactant one and reactant two.

In a preferred embodiment, one end of the first inner tube 11 connected to the second inner tube 21 is trumpet shaped. One end of the first middle tube 12 connected to the second middle tube 22 also has a trumpet shape, and the trumpet shaped structure can generate secondary reflux of reactants to prevent a formation of dead zones.

The second inner tube 21 is connected to the first inner tube 11, that is, one side of the second inner tube 21 is connected to a trumpet shaped arc-shaped edge at the other side of the first inner tube 11; the second middle tube 22 is connected to the first middle tube 12, that is, one side of the second middle tube 22 is connected to a trumpet shaped arc-shaped edge at the other side of the first middle tube 12; connecting the first inner annular gap 14 with the second inner annular gap 24, sealing two free ends of the first outer annular gap 15, and sealing two free ends of the second outer annular gap 25.

Further in some embodiments, an angle between the first conical hole 121 and the tube wall of the first middle tube 12 is 45-75°, and inner diameters of first conical holes 121 are 0.1-1 mm. An uneven distribution of the first conical holes 121 can enhance a jet effect. The first conical holes forms a 45-75° angle with the tube wall, balancing shear and energy consumption. The inner diameters of the conical holes is 0.1-1 mm, which can maintain sufficient pressure and velocity of a fluid jet within the range of diameter. A combination of unevenly distributed conical holes and diameter-varying tubes forms shear vortices in a jet area, which enhancing a jet velocity, reducing clogging of high-viscosity systems, and improving a mixing uniformity of reactants.

### Embodiment 2

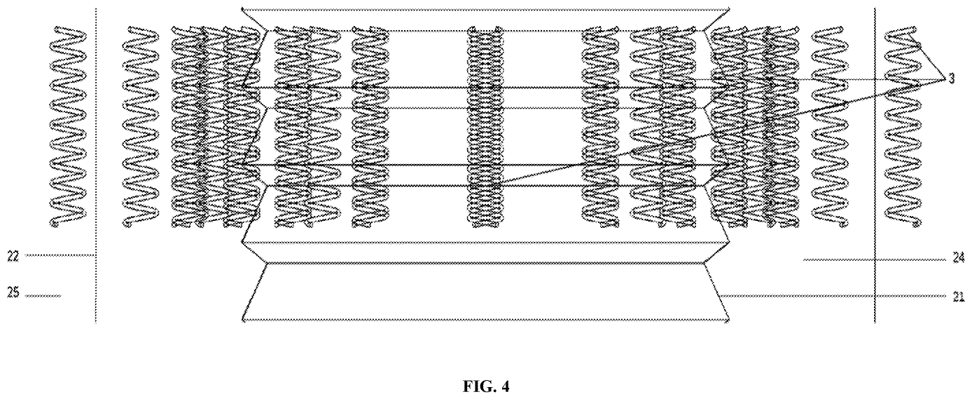

As shown in FIG. 4, further, in the second inner annular gap 24, several spiral deflectors 3 are set near the outer wall of the second inner tube 21 and the inner wall of the second middle tube 22; and in the second outer annular gap 25, several spiral deflectors 3 are set near the outer wall of the second middle tube 22. At the same time, several spiral deflectors 3 are also provided in an area near the inner wall of the second inner tube 21. That is, areas near the inner and outer walls of the second inner tube 21, as well as areas near the inner and outer walls of the second middle tube 22, are both set with spiral deflectors 3. A setting of the spiral deflectors 3 effectively improves a mixing effect of reactants and transfers reaction heat in a timely manner, enhances a heat exchange effect around cold and hot tubes.

The three-layer nested tube microchannel jet reactor with spiral deflectors 3 included in the second inner tube 21, second inner annular gap 24, and second outer annular gap 25 is selected for implementation. A reactant one is introduced into the reactor through the second working fluid flow port 123 at one side of the first inner annular gap 14. A reactant two is added to the reactor through the third working fluid flow port 131 at one side of the first outer annular gap 15. The reactant two enters the first inner annular gap 14 through several first conical holes 121 on the outer wall of the first middle tube 12 and mixes with reactant one. A mixed material in the first inner annular gap 14 will undergo secondary reflux and be further mixed after passing through the first arc-shaped deflectors 111 on the outer wall of the first inner tube 11. The mixed material flows downwards into the connected second inner annular gap 24. Under an action of the corrugated outer wall of the second inner tube 21, the mixed material will experience turbulence. Finally, the mixed material flows out through the sixth working fluid flow port 221 at the other side of the second inner annular gap 24. Due to a large amount of heat generated by the reaction, condensate liquid is provided in the first inner tube 11, the second inner tube 21, and the second outer annular gap 25. The spiral deflectors 3 distributed in the second inner tube 21, the second inner annular gap 24, and the second outer annular gap 25 will accelerate a transfer of heat. Results showed that compared with a three-layer nested tube microchannel jet reactor under same experimental conditions, a three-layer nested tube microchannel jet reactor containing spiral deflectors 3 greatly improved an efficiency of reaction heat conversion, provided basic conditions for stable reaction, and also improved safety of the reactor.

### Embodiment 3

In a preferred embodiment, the first inner tube 11 and the first outer tube 13 are both straight tubes, and the first middle tube 12 is a diameter-varying tube. The first middle tube 12 includes a first tube body 41, a second tube body 42, a third tube body 43, a fourth tube body 44, a fifth tube body 45, and a sixth tube body 46 that are sequentially connected and arranged; where the first tube body 41, the second tube body 42, the third tube body 43, the fourth tube body 44, the fifth tube body 45, and the sixth tube body 46 can be integrated. A cross-section of the second tube body 42 along an axial direction of the second tube body 42 is trapezoidal, and an inner diameter of the second tube body 42 gradually decreases from an end of the second tube body 42 connected to the first tube body 41 to an other end of the second tube body 42 connected to the third tube body 43; a cross-section of the fourth tube body 44 along an axial direction of the fourth tube body 44 is trapezoidal, and an inner diameter of the fourth tube body 44 gradually increases from an end of the fourth tube body 44 connected to the third tube body 43 to an other end of the fourth tube body 44 connected to the fifth tube body 45. That is, the first middle tube 12 has a dumbbell like structure; where the other end of the first middle tube 12 is trumpet shaped, that is, an inner diameter of the sixth tube body 46 gradually decreases along the direction from the sixth tube body 46 to the fifth tube body 45. An inner diameter of the first middle tube 12 is 0.2-0.5 mm, within which a diameter-varying tube achieves the best jet effect.

The first middle tube 12 is a diameter-varying tube, and an angle between the second tube body 42 and the fourth tube body 44 and the axial direction is 18-28°. A design of the diameter-varying tube can form a shear-layer vortex in the first inner annular gap, enhancing a mixing effect. Forming an angle of 18-28° with a circumferential direction can avoid energy loss and insufficient kinetic energy for acceleration. A design of the diameter-varying tube with an angle of 18-28° with an axial direction provides appropriate pressure for the system within the first inner annular gap, where providing sufficient power for dispersion of high-viscosity fluids, ensuring uniform dispersion of high-viscosity fluids, while also ensuring dissipation of excess energy.

In a preferred embodiment, the first arc-shaped deflectors 111 are positioned in an area coinciding with axial positions of the fourth pipe body 44 and the fifth pipe body 45.

Several first conical holes 121 are set on the outer wall of the third tube body 43, and the several first conical holes 121 are uniformly distributed in an area of the outer wall.

A three-layer nested tube microchannel jet reactor with the first middle tube 22 as a diameter-varying tube is selected for implementation. A reactant one is introduced into the reactor through the second working fluid flow port 123 at an end of the first inner annular gap 14. The reactant two is added to the reactor through the third working fluid flow port 131 at an end of the first outer annular gap 15. The reactant two is sprayed into the first inner annular gap 14 through the first conical holes 121 on the first middle tube 12 and mixed with reactant one. Due to the variable diameter of the first middle tube 12 and an uneven distribution of several first conical holes 121, low-pressure vortices will form in a minimum-inner-diameter area, fully mixing materials to obtain mixed material. The mixed material in the first inner annular gap 14 will undergo secondary reflux and further mix after passing through the first arc-shaped deflectors 111 on the outer wall of the first inner tube 11. The mixed material flows downwards into the connected second inner annular gap 24. Under an action of corrugated outer wall of the second inner tube 21, the mixed material will experience turbulence. Finally, the mixed material flows out through the sixth working fluid flow port 221 at the other side of the second inner annular gap 24. Results showed that compared with a three-layer nested tube microchannel jet reactor under same experimental conditions, a three-layer nested tube microchannel jet reactor containing a diameter-varying tube enhanced a jet effect, improving material mixing, and reducing probability of blockage of high-viscosity fluids.

### Embodiment 4

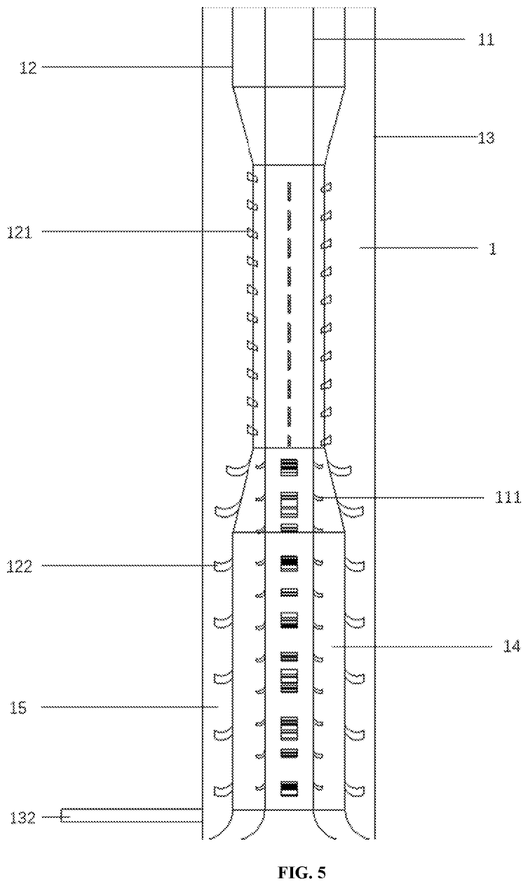

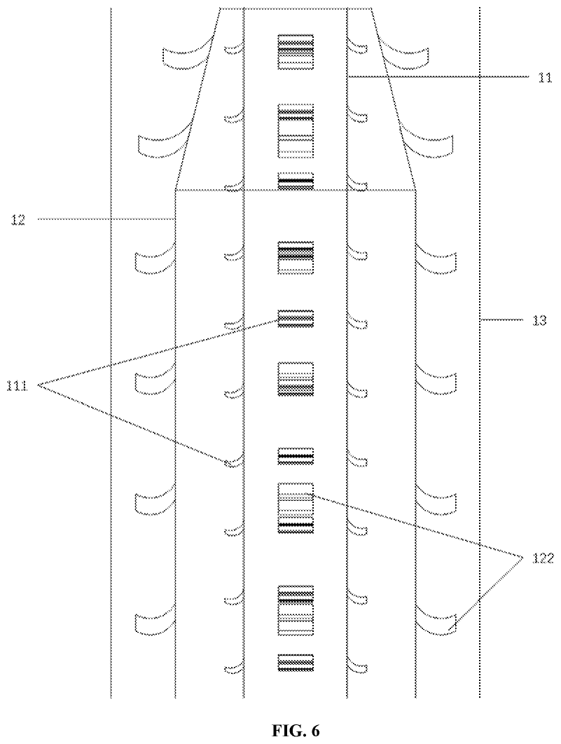

As shown in FIGS. 5-6, preferably, the outer wall of the first middle pipe 12 is provided with several second arc-shaped deflectors 122. The second arc-shaped deflectors 122 are arranged on the outer walls of the fourth tube body 44 and the fifth tube body 45; and preferably, several second arc-shaped deflectors 122 are uniformly arranged on the outer walls of the fourth tube body 44 and the fifth tube body 45.

A surface area of the second arc-shaped deflectors 122 is larger than a surface area of the first arc-shaped deflectors 111.

### Embodiment 5

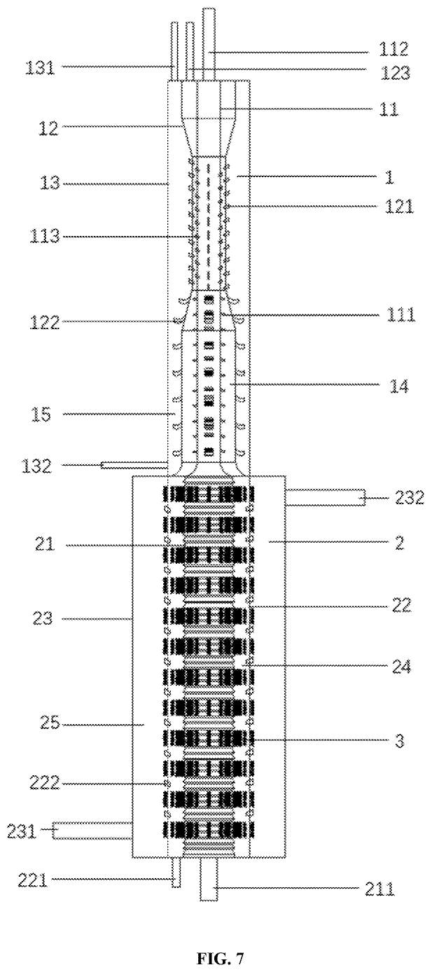

As shown in FIG. 7, in order to facilitate an introduction of a third phase working fluid, in the preferred embodiment of the present disclosure, several second conical holes 113 are provided on the first inner tube 11 or several third conical holes 222 are provided on the second middle tube 22.

When several second conical holes 113 are provided on the first inner tube 11, the first working fluid flow port 112, the second working fluid flow port 123, and the third working fluid flow port 131 are respectively used as inflow ports for reactant one, reactant two, and reactant three. Reactant one enters the first inner tube 11 through the first working fluid flow port 112, reactant two enters the interior of the first inner tube 11 through the second conical holes 113 provided on the first inner tube 11, and reactant three enters the interior of the first inner tube 11 through the third working fluid flow port 131, the first conical holes 121, and the second conical holes 113 in sequence, achieving a mixing of reactant one, reactant two and reactant three.

When several third conical holes 222 are provided on the second middle tube 22, the second working fluid flow port 123, the third working fluid flow port 131, and the third conical holes 222 are respectively used as the inflow ports for reactant one, reactant two, and reactant three. Reactant one enters the first inner annular gap 14 through the second working fluid flow port 123, reactant two enters the first inner annular gap 14 through the third working fluid flow port 131 and the first conical holes 121. Reactant one and reactant two enter the first inner annular gap 14 and continue to run downward, entering the second inner annular gap 24. Then, reactant three enters the second inner annular gap 24 through the third conical holes 222 and reacts with reactant one and reactant two, achieving a mixing of three reactants. In addition, the fifth working fluid flow port 211 and the first working fluid flow port 112 can be used as an inlet and outlet of a condensing working fluid, where realizing temperature control during a reaction process of reactant one, reactant two and reactant three in the second inner annular gap 24.

The present disclosure combines three-layer nested tube microchannel technology and microjet technology to propose a three-layer nested tube microchannel jet reactor. Compared with traditional microchannel reactors, a mixing efficiency of the three-layer nested tube microchannel jet reactor is significantly improved. Traditional microchannel reactors rely on molecular diffusion or laminar shear mixing, which is insufficient for high-viscosity fluids or rapid reactions. The microchannel jet reactor generates high-intensity turbulence through microjets, where achieving millisecond level efficient mixing. A heat transfer coefficient can reach 2-5 times that of traditional designs, effectively controlling temperature of strong exothermic reactions. By adjusting a jet velocity, a mixing sequence and residence time can be precisely controlled to avoid side reactions. A high shear force of microjet can crush particles or bubbles, where reducing a risk of microchannel blockage. Compared with a dual-layer nested tube microchannel jet reactor, the three-layer nested tube microchannel jet reactor can achieve multi-stage regulation and axial temperature gradient control of a reaction channel.

The above are only preferred embodiments of the present disclosure and are not intended to limit the present disclosure. For those skilled in the art, the present disclosure may have various modifications and variations. Any modifications, equivalent substitutions, improvements, etc. made within a spirit and principles of the present disclosure shall be included within a scope of protection of the present disclosure.

What is claimed is:

1. A three-layer nested tube microchannel jet reactor, comprising: a first tube section (1) and a second tube section (2);
wherein the first tube section (1) comprises: a first inner tube (11), a first middle tube (12), and a first outer tube (13) coaxially sleeved; wherein a first inner annular gap (14) is formed between the first inner tube (11) and the first middle tube (12); and a first outer annular gap (15) is formed between the first middle tube (12) and the first outer tube (13);
wherein the first middle tube (12) is set with several first conical holes (121); and wherein an outer wall of the first inner tube (11) is set with several first arc-shaped deflectors (111);
wherein the second tube section (2) comprises: a second inner tube (21), a second middle tube (22), and a second outer tube (23); wherein a second inner annular gap (24) is formed between the second inner tube (21) and the second middle tube (22); and a second outer annular gap (25) is formed between the second middle tube (22) and the second outer tube (23);
wherein the second inner tube (21) is connected to the first inner tube (11), and the second middle tube (22) is connected to the first middle tube (12), and wherein the first inner annular gap (14) is connected to the second inner annular gap (24).

2. The three-layer nested tube microchannel jet reactor according to claim 1, wherein the first middle tube (12) comprises: a first tube body (41), a second tube body (42), a third tube body (43), a fourth tube body (44), a fifth tube body (45), and a sixth tube body (46), wherein the first tube body (41), the second tube body (42), the third tube body (43), the fourth tube body (44), the fifth tube body (45), and the sixth tube body (46) are sequentially connected and integrated; a cross-section of the second tube body (42) along an axial direction of the second tube body (42) is trapezoidal, and an inner diameter of the second tube body (42) gradually decreases from a first end of the second tube body (42) connected to the first tube body (41) to a second end of the second tube body (42) connected to the third tube body (43); a cross-section of the fourth tube body (44) along an axial direction of the fourth tube body (44) is trapezoidal, and an inner diameter of the fourth tube body (44) gradually increases from a first end of the fourth tube body (44) connected to the third tube body (43) to a second end of the fourth tube body (44) connected to the fifth tube body (45).

3. The three-layer nested tube microchannel jet reactor according to claim 2, wherein the sixth tube body (46) is trumpet shaped; and wherein an end of the first inner tube (11) connected to the second inner tube (21) is trumpet shaped.

4. The three-layer nested tube microchannel jet reactor according to claim 2, wherein first arc-shaped deflectors (111) are set in an area where the fourth tube body (44) and the fifth tube body (45) coincide along an axial direction.

5. The three-layer nested tube microchannel jet reactor according to claim 2, wherein the first conical holes (121) are set on an outer wall of the third tube body (43).

6. The three-layer nested tube microchannel jet reactor according to claim 2, wherein several second arc-shaped deflectors (122) are set on an outer wall of the fourth tube body (44) and an outer wall of the fifth tube body (45).

7. The three-layer nested tube microchannel jet reactor according to claim 1, wherein spiral deflectors (3) are arranged on an inner wall and an outer wall of the second inner tube (21) and an inner wall and an outer wall of the second middle tube (22).

8. The three-layer nested tube microchannel jet reactor according to claim 1, wherein an outer wall of the second inner tube (21) is corrugated.

9. The three-layer nested tube microchannel jet reactor according to claim 5, wherein several second conical holes (113) are set on the first inner tube (11), and wherein axial positions of the second conical holes (113) coincide with axial positions of the first conical holes (121), wherein each of the second conical holes (113) along an axial direction of the first inner tube (11) coincides with each of the first conical holes (121) along the axial direction of the first inner tube (11) one by one.

10. The three-layer nested tube microchannel jet reactor according to claim 1, wherein several third conical holes (222) are set on the second middle tube (22).
